(19) United States
(12) Patent Application Publication
(10) Pub. No.: US 2018/0189687 A1
(43) Pub. Date: Jul. 5, 2018

(54) TERMINAL APPARATUS, RESERVATION SERVER, AND PROCESSING METHOD OF TERMINAL APPARATUS

(71) Applicant: NEC Corporation, Tokyo (JP)

(72) Inventor: Tsuyoshi OIKAWA, Tokyo (JP)

(73) Assignee: NEC Corporation, Tokyo (JP)

(21) Appl. No.: 15/861,824

(22) Filed: Jan. 4, 2018

(30) Foreign Application Priority Data
Jan. 5, 2017 (JP) 2017-000379

(51) Int. Cl. G06Q 10/02; G06Q 10/10; H04W 4/02; G06F 3/0484

(52) U.S. Cl. CPC G06Q 10/02; G06F 3/0484; H04W 4/02; G06Q 10/1095

(57) ABSTRACT

According to the present invention, a terminal apparatus is provided which includes an information acquisition unit that transmits, to a reservation server, terminal information indicating a position of an own terminal, and receives, from the reservation server, facility information indicating a facility and a position thereof, a positional relationship between the facility and the own terminal satisfying a predetermined condition; a display control unit that causes a display unit to display a camera-generated image generated by a camera and to display a reservation button on the camera-generated image at a position corresponding to the position of the facility indicated by the facility information; and a reservation processing unit that executes, when the reservation button is operated, reservation processing for reserving the facility corresponding to the reservation button.

This application is based on Japanese Patent Application No. 2017-000379 filed on Jan. 5, 2017, the content of which is incorporated hereinto by reference.

### BACKGROUND

### Technical Field

The present invention relates to a terminal apparatus, a reservation server, a reservation system, a processing method of a terminal apparatus, a processing method of a reservation server, and a program.

### Related Art

Japanese Patent Application Publication No. 2011-227847 discloses a meeting room reservation assistant system that selects a meeting room on the basis of a reservation condition from a reserving person. The meeting room reservation assistant system includes a meeting room information storage unit, a reserving person information storage unit, a reservation condition input unit, and a meeting room search unit.

The meeting room information storage unit stores meeting room information such as the position, room capacity, and reservation status of each meeting room. The reserving person information storage unit stores information on the reserving person such as the department to which each reserving person belongs and an available meeting room. The reservation condition input unit inputs reservation condition such as the date and time of use of a meeting room and the number of users. The meeting room search unit searches for a meeting room which is appropriate for the reservation condition inputted by the reservation condition input unit and which is available to the reserving person who has inputted the reservation condition, on the basis of the meeting room information stored in the meeting room information storage unit and the reserving person information stored in the reserving person information storage unit. For example, the document discloses that a meeting room is selected on the basis of a distance between the meeting room and the department to which the reserving person belongs.

In a case of a technique disclosed in Japanese Patent Application Publication No. 2011-227847, a user making the reservation cannot intuitively recognize the position or direction of a meeting room to be reserved. As a result, the inconvenience of reserving an unintended meeting room or the like occurs. Such inconvenience may occur not only in reserving meeting rooms but also other facilities.

The problem to be solved by the present invention is to allow to intuitively recognize the position or direction of a facility to be reserved when making a reservation.

### SUMMARY

In one embodiment, there is provided a terminal apparatus including: an information acquisition unit that transmits, to a reservation server, terminal information indicating a position of an own terminal, and receives, from the reservation server, facility information indicating a facility and a position thereof, a positional relationship between the facility and the own terminal satisfying a predetermined condition; a display control unit that causes a display unit to display a camera-generated image and to display a reservation button on the camera-generated image at a position corresponding to the position of the facility indicated by the facility information; and a reservation processing unit that executes, when the reservation button is operated, reservation processing for reserving the facility corresponding to the reservation button.

In another embodiment, there is provided a reservation server including: an information providing unit that receives, from a terminal apparatus, terminal information indicating a position of the terminal apparatus, and transmits, to the terminal apparatus, facility information indicating a facility and a position thereof, a positional relationship between the facility and the terminal apparatus satisfying a predetermined condition; and a reservation unit that receives, from the terminal apparatus, reservation information for reserving any one facility indicated by the facility information, and performs reservation processing.

In still another embodiment, there is provided a reservation system including the terminal apparatus and the reservation server.

In still another embodiment, there is provided a processing method of a terminal apparatus, the method including the steps, executed by a computer, of: an information acquisition step of transmitting, to a reservation server, terminal information indicating a position of an own terminal, and receiving, from the reservation server, facility information indicating a facility and a position thereof, a positional relationship between the facility and the own terminal satisfying a predetermined condition; a display control step of causing a display unit to display a camera-generated image and to display a reservation button on the camera-generated image at a position corresponding to the position of the facility indicated by the facility information; and a reservation processing step of executing, when the reservation button is operated, reservation processing for reserving the facility corresponding to the reservation button.

In still another embodiment, there is provided a program causing a computer to function as: an information providing unit that receives, from a terminal apparatus, terminal information indicating a position of the terminal apparatus, and transmits, to the terminal apparatus, facility information indicating a facility and a position thereof, a positional relationship between the facility and the terminal apparatus satisfying a predetermined condition; and a reservation unit that receives, from the terminal apparatus, reservation information for reserving any one facility indicated by the facility information, and performs reservation processing.

In still another embodiment, there is provided a processing method of a reservation server, the method including the steps, executed by a computer, of: an information providing step of receiving, from a terminal apparatus, terminal information indicating a position of the terminal apparatus, and transmitting, to the terminal apparatus, facility information indicating a facility and a position thereof, a positional relationship between the facility and the terminal apparatus satisfying a predetermined condition; and a reservation step of receiving, from the terminal apparatus, reservation information for reserving any one facility indicated by the facility information, and performing reservation processing.

In still another embodiment, there is provided a program causing a computer to function as: an information providing unit that receives, from a terminal apparatus, terminal information indicating a position of the terminal apparatus, and transmits, to the terminal apparatus, facility information indicating a facility and a position thereof, a positional relationship between the facility and the terminal apparatus satisfying a predetermined condition; and a reservation unit that receives, from the terminal apparatus, reservation information for reserving any one facility indicated by the facility information, and performs reservation processing.

According to the present invention, it is possible to intuitively recognize the position or direction of a facility to be reserved during reservation work.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a diagram conceptually illustrating an example of a hardware configuration of an apparatus of the present example embodiment;

FIG. 2 is an example of a functional block diagram of a terminal apparatus of the present example embodiment;

FIG. 3 is a diagram schematically illustrating an example of a screen which is displayed on a display apparatus by the terminal apparatus of the present example embodiment;

FIG. 4 is a diagram schematically illustrating an example of a screen which is displayed on the display apparatus by the terminal apparatus of the present example embodiment;

FIG. 5 is a diagram schematically illustrating an example of a screen which is displayed on the display apparatus by the terminal apparatus of the present example embodiment;

FIG. 6 is a flow diagram illustrating an example of a flow of processes of the terminal apparatus of the present example embodiment;

FIG. 7 is a diagram schematically illustrating an example of information which is registered with a reservation server of the present example embodiment.

FIG. 8 is a diagram schematically illustrating an example of information which is registered with the reservation server of the present example embodiment;

FIG. 9 is an example of a functional block diagram of the reservation server of the present example embodiment;

FIG. 10 is a flow diagram illustrating an example of a flow of processes of the reservation server of the present example embodiment;

FIG. 11 is a diagram schematically illustrating an example of a screen which is displayed on the display apparatus by the terminal apparatus of the present example embodiment;

FIG. 12 is a flow diagram illustrating an example of a flow of processes of the terminal apparatus of the present example embodiment;

FIG. 13 is a flow diagram illustrating an example of a flow of processes of the terminal apparatus of the present example embodiment; and

FIG. 14 is a flow diagram illustrating an example of a flow of processes of the reservation server of the present example embodiment.

### DETAILED DESCRIPTION

The invention will be now described herein with reference to illustrative embodiments. Those skilled in the art will recognize that many alternative embodiments can be accomplished using the teachings of the present invention and that the invention is not limited to the embodiments illustrated for explanatory purposes.

### First Embodiment

First, the outline of the present example embodiment will be described. A reservation system of the present example embodiment includes a terminal apparatus and a reservation server. The reservation system of the present example embodiment is a system using augmented reality (AR), more specifically, an air tag.

In the reservation system of the present example embodiment, an air tag is registered with the reservation server. The air tag is for reserving each of a plurality of facilities in association with position information of each facility, that is, the air tag is information for displaying a reservation button on a screen corresponding to each facility. When a user operates the terminal apparatus to start up reservation software, a camera-generated image is displayed on a display apparatus in real time, and the reservation button (air tag) corresponding to each facility is displayed corresponding to the position of each facility on the camera-generated image. When the reservation button is operated, the step proceeds to a step of reserving the facility.

According to such a reservation system of the present example embodiment, it is possible to intuitively recognize the position or direction of a facility to be reserved when making a reservation.

Next, an example of the hardware configuration of the terminal apparatus and the reservation server of the present example embodiment will be described. Each functional unit included in each of the terminal apparatus and the reservation server of the present example embodiment is embodied by any combination of hardware and software based on a central processing unit (CPU), a memory, and a program loaded into the memory, a storage unit (which is capable of storing a program downloaded from a recording medium such as a compact disc (CD), a server on the Internet, or the like, in addition to a program stored in advance before the shipping stage) such as a hard disk having the program stored thereon, and an interface for network connection of any computer. It will be understood by those skilled in the art that embodying methods and apparatuses thereof may be modified in various ways.

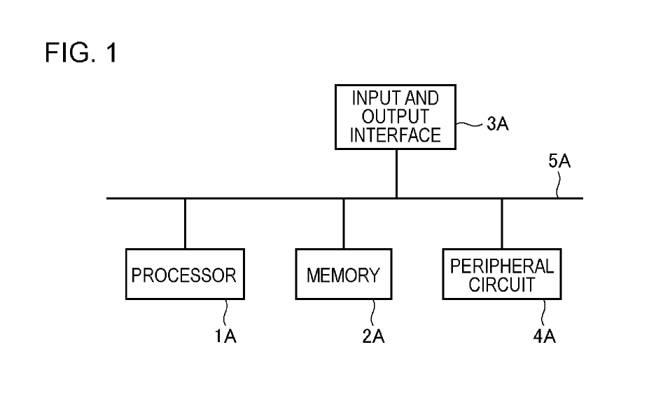

FIG. 1 is a block diagram illustrating a hardware configuration of each of the terminal apparatus and the reservation server of the present example embodiment. As described in FIG. 1, each of the terminal apparatus and the reservation server includes a processor 1A, a memory 2A, an input and output interface 3A, a peripheral circuit 4A, and a bus 5A. Various modules are included in the peripheral circuit 4A. Note that the peripheral circuit 4A may not be included.

The reservation server may be implemented by one apparatus which is integrally formed physically and/or logically formed, or may be implemented by a plurality of apparatuses which are physically and/or logically separated from each other. In the latter case, each of the plurality of apparatuses may include the hardware configuration as shown in FIG. 1. The plurality of apparatuses may implement a function of the reservation server in cooperation with each other.

The bus 5A is a data transmission channel in order for the processor 1A, the memory 2A, the peripheral circuit 4A and the input and output interface 3A to mutually transmit and receive data. The processor 1A is an arithmetic processing apparatus such as, for example, a central processing unit (CPU) or a graphics processing unit (GPU). The memory 2A is a memory such as, for example, a random access memory (RAM) or a read only memory (ROM). The input and output interface 3A includes an interface for acquiring information from an input apparatus (such as, for example, a keyboard, a mouse, or a microphone), an external apparatus, an external server, or an exterior sensor, an interface for outputting information to an output apparatus (such as, for example, a display apparatus, a speaker, a printer, or a mailer), an external apparatus, or an external server, and the like. The processor 1A is capable of issuing a command to each module and performing an arithmetic operation on the basis of the arithmetic results of the commands.

Next, the function of the reservation system of the present example embodiment will be described. The reservation system includes the terminal apparatus and the reservation server. The terminal apparatus and the reservation server are connected to a network such as the Internet, and are configured to be capable of communicating with each other.

First, the function of the terminal apparatus will be described. The terminal apparatus is a portable terminal which is carried by a user, and has a camera function, a communication function, and the like. Examples of the terminal apparatus to be exemplified include a smartphone, a cellular phone, a tablet, a notebook personal computer (PC), and the like, but there is no limitation thereto.

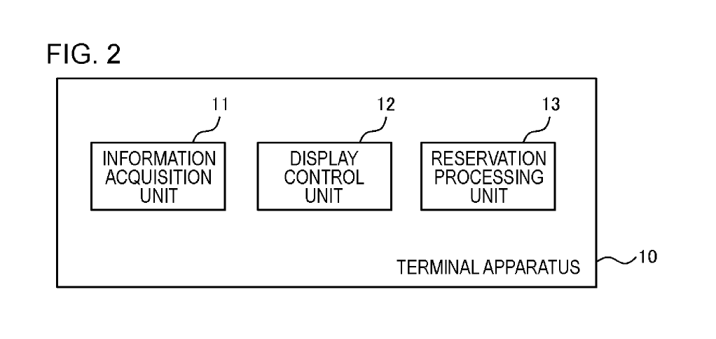

FIG. 2 describes an example of a functional block diagram of a terminal apparatus 10 of the present example embodiment. As described in the drawing, the terminal apparatus 10 includes an information acquisition unit 11, a display control unit 12, and a reservation processing unit 13. For example, the functions of these units are implemented by installing predetermined reservation software on the terminal apparatus 10.

The information acquisition unit 11 transmits terminal information indicating the position of an own terminal to the reservation server, and receives from the reservation server facility information indicating a facility and a position thereof, a positional relationship between the facility and the own terminal satisfying a predetermined condition.

First, the information acquisition unit 11 includes a unit that acquires position information indicating the current position of the own terminal. The position information is indicated by, for example, latitude, longitude, altitude, or the like. The configuration of the unit that acquires the position information is not particularly limited, and any technique using, for example, a global positioning system (GPS), a wireless LAN access point, an atmospheric pressure sensor, or the like may be adopted.

In addition, the information acquisition unit 11 includes a unit that acquires direction information indicating the direction of the camera included in the own terminal. The direction information is indicated by, for example, a facing direction of the camera, the inclination angle of the terminal apparatus, or the like. The configuration of the unit that acquires the direction information is not particularly limited, and any technique using, for example, an electronic compass, an acceleration sensor, a gyro sensor, or the like may be adopted.

In addition, the information acquisition unit 11 includes a unit that transmits terminal information indicating the position of the own terminal to the reservation server. The direction information may be further included in the terminal information which is transmitted to the reservation server. The address of the reservation server is registered with the terminal apparatus 10 in advance. For example, the address of the reservation server is registered with the terminal apparatus 10 when reservation software is installed on the terminal apparatus 10.

In addition, the information acquisition unit 11 includes a unit that receives, from the reservation server, facility information indicating a facility and a position thereof, the positional relationship between the facility and the own terminal satisfying a predetermined condition. An air tag (reservation button) is displayed on a camera-generated image using the facility information. As described below, facility information corresponding to each of a plurality of facilities is registered with the reservation server in advance. The facility information includes information for identifying a facility (for example, facility name), information indicating the position of a facility, or the like. The position of a facility indicates the position of a representative point of a facility such as, for example, latitude, longitude, or altitude. A unit that extracts facility information which is replied to the terminal apparatus 10 by the reservation server on the basis of the terminal information is not particularly limited, and any AR technique may be used.

The facility includes any facility which is used by reserving in advance. For example, a room such as a meeting room or an audiovisual room, an athletic facility, a recreational facility, and the like are exemplified, but there is no limitation thereto.

The display control unit 12 causes a display unit (such as a display apparatus) to display a camera-generated image at the time in real time, and to display a reservation button (air tag) at a position on the camera-generated image corresponding to the position of a facility indicated by the facility information. The display control unit 12 determines the air tag or the position thereof to be superimposedly displayed on the camera-generated image, on the basis of the current position of the own terminal, a facing direction of the camera, the inclination angle of the terminal apparatus, or the like. A unit of the display control unit 12 that displays an air tag at a predetermined position on a camera-generated image is not particularly limited, and any AR technique may be used.

The reservation button which is displayed on a camera-generated image includes at least information (for example, facility name) for identifying a facility. Besides, the reservation button may include an operation guide such as “Tap button to make a reservation”.

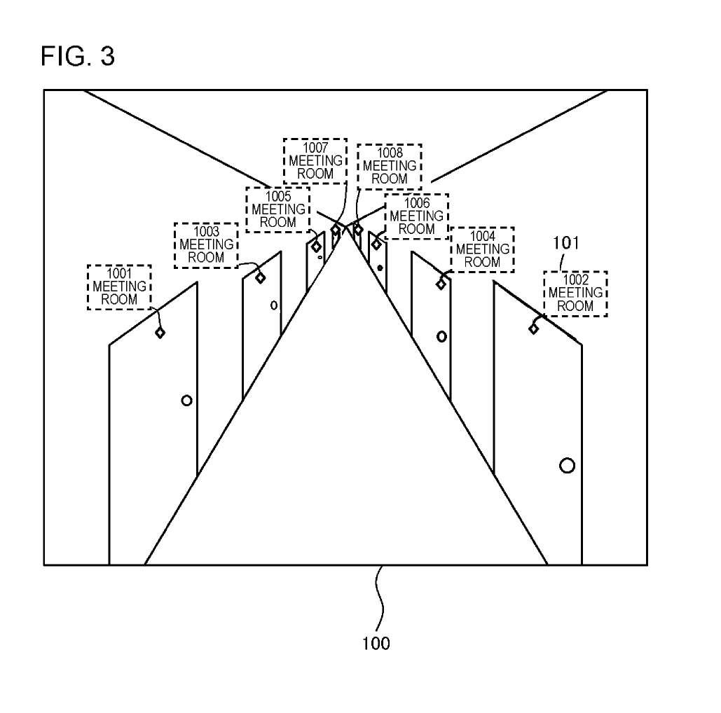

FIG. 3 describes an example of a screen which is displayed on a display apparatus by the display control unit 12. In the example, a screen 100 includes a camera-generated image. A corridor and doors of meeting rooms (facilities) are captured in the camera-generated image. In a case where a user changes the direction of the camera, the camera-generated image changes accordingly. The screen 100 further includes a plurality of reservation buttons 101 (air tags) superimposed on the camera-generated image. Each of the plurality of reservation buttons 101 includes the name of the corresponding meeting room.

Referring back to FIG. 2, in a case where an operation is performed on a reservation button, the reservation processing unit 13 executes reservation processing for reserving the corresponding facility. For example, the reservation processing unit 13 causes the display unit to display an input screen for inputting the details of the reservation in cooperation with the display control unit 12, or transmits reservation information including information input through the input screen to the reservation server to request for the reservation to be processed. The reservation information includes identification information (for example, facility name) of the facility, the date and time (date and time of use), identification information of the user, and the like.

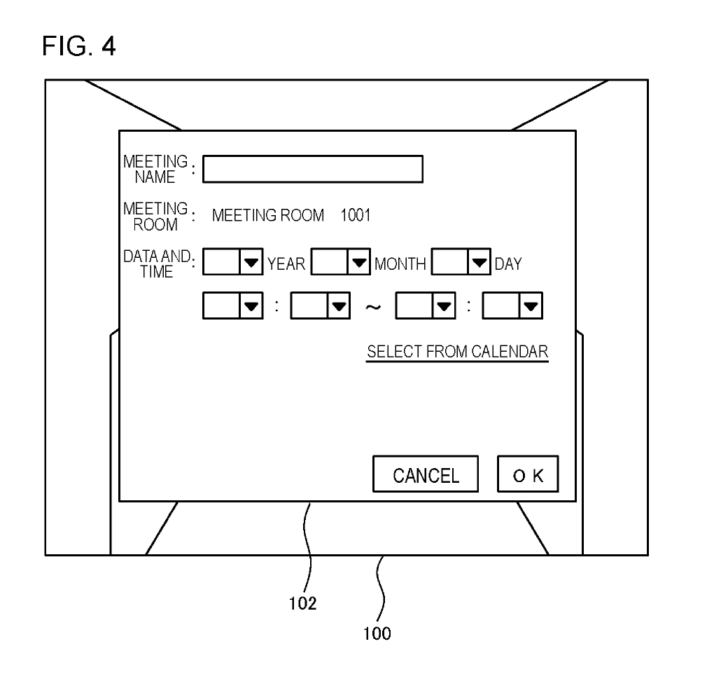

Here, an example of reservation processing performed by the reservation processing unit 13 will be described by taking an example of a case of reserving a meeting room. For example, on the screen 100 shown in FIG. 3, in a case where an operation (for example, tapping) is performed on the reservation button 101 of a meeting room 1001, the reservation processing unit 13 causes the display unit to display an input screen including an entry field for inputting the details of the reservation, in cooperation with the display control unit 12. FIG. 4 describes an example. In the example, an input screen is displayed in a window 102. The input screen has entry fields of the date and time and the name of the meeting. The entry field of the meeting name may not be included. In a case where a cancel button is operated on the input screen, the screen returns to the screen 100 described in FIG. 3. In a case where inputs to the entry fields are completed on the input screen and then an OK button is operated, the reservation processing unit 13 transmits reservation information including the meeting name, identification information of the meeting room, the date and time, the user's identification information, and the like to the reservation server. The user's identification information is registered with the terminal apparatus 10, for example, through the reception of input during the initial startup of the reservation software. In this case, the identification information may be registered through the further reception of input of the user's department, age, title, contact (such as telephone number, e-mail address, or address), and the like.

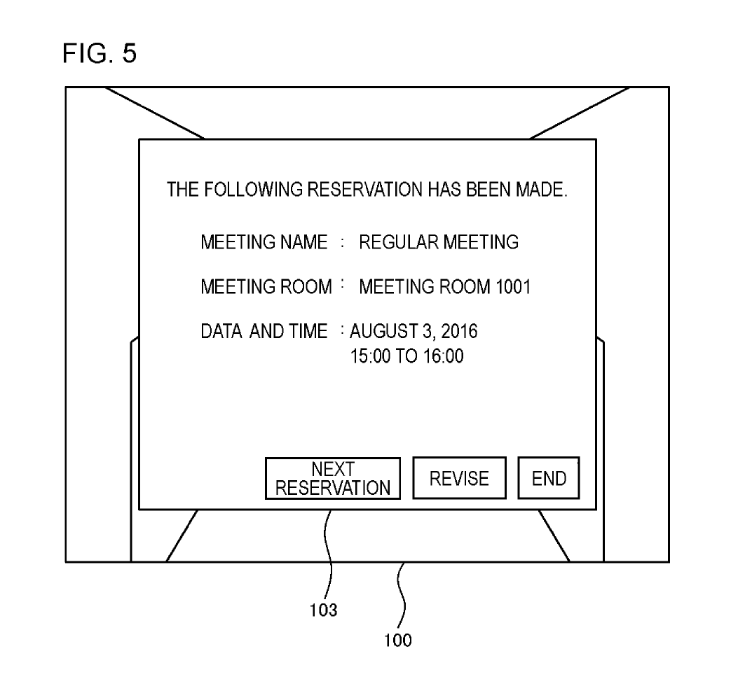

As described below, the reservation server performs reservation processing on the basis of received reservation information. When the reservation is completed, the reservation server replies a reservation completion notification to the terminal apparatus 10. The reservation processing unit 13 cooperates with the display control unit 12, and causes the display unit to display a notification screen indicating completion of reservation in accordance with the reception of the reservation completion notification. FIG. 5 describes an example. In the example, a notification screen is displayed in a window 103. The notification screen notifies of the details of the reservation and the completion of the reservation. In a case where the next reservation button is operated on the notification screen, the screen returns to the screen 100 described in FIG. 3. In a case where a revise button is operated on the notification screen, the screen returns to, for example, the screen 100 described in FIG. 4. In a case where an end button is operated on the notification screen, the reservation software is ended, and the screen returns to, for example, a home screen.

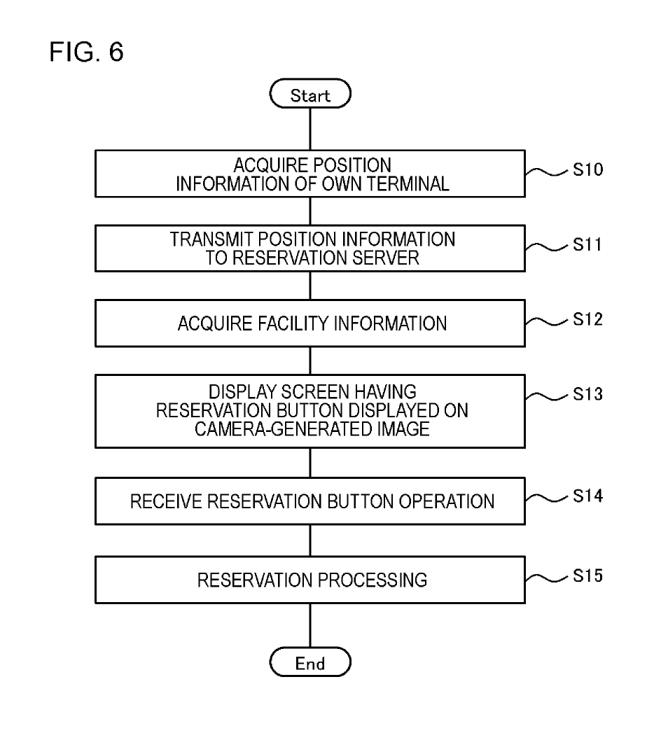

Next, an example of a flow of processes of the terminal apparatus 10 will be described with reference to a flow diagram of FIG. 6.

In a case where the terminal apparatus 10 is operated to start the reservation software (or when, after starting the reservation software, an input operation is performed for starting reservation processing), the information acquisition unit 11 acquires position information indicating the current position of the own terminal in accordance with the operation (S10). The information acquisition unit 11 then transmits the position information to the reservation server (S11). Note that, the information acquisition unit 11 may further acquire direction information of the own terminal in S10, and further transmit the direction information of the own terminal to the reservation server in S11. Thereafter, the information acquisition unit 11 receives facility information replied from the reservation server (S12).

Next, the display control unit 12 causes the display unit to display a screen having a reservation button, corresponding to a facility, superimposedly displayed on a camera-generated image, using the facility information received in S12 (S13). In a case where an operation of the reservation button is received on the screen (S14), the reservation processing unit 13 executes reservation processing for reserving a facility corresponding to the reservation button (S15). The details of the reservation processing are as described above.

Next, the function of the reservation server will be described. The reservation server may be constituted by a plurality of servers which are physically and/or logically separated from each other, and may be constituted by one server which is integrally formed physically and/or logically. In the former case, for example, the reservation server may be divided into a facility information management server that manages facility information for implementing an air tag display and a reservation management server that manages the reservation status or the like of a facility.

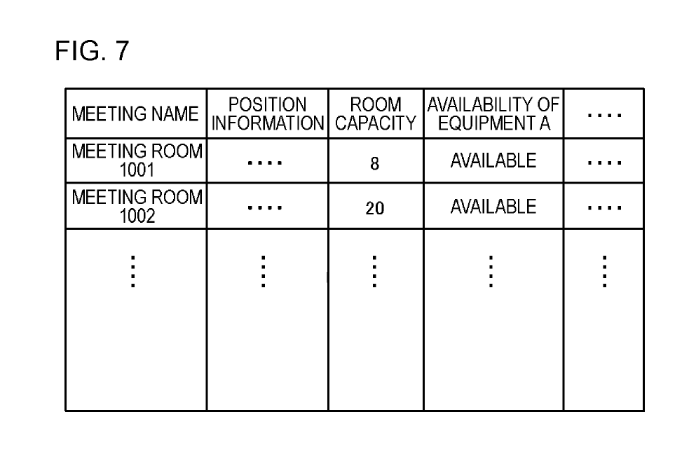

As described in FIG. 7, position information and attribute information of each of a plurality of facilities are registered with a reservation server (for example, facility management server) 20 in advance. FIG. 7 describes an example in a case where a facility is a meeting room. In FIG. 7, position information, room capacity, the availability of equipment A (such as, for example, a whiteboard, a projector, a television, or a telephone meeting system), and the like of each of a plurality of facilities are registered. Note that, the attribute information is merely an example, and there is no limitation thereto. The position information indicates the position of a representative point of a facility such as, for example, latitude, longitude, or altitude.

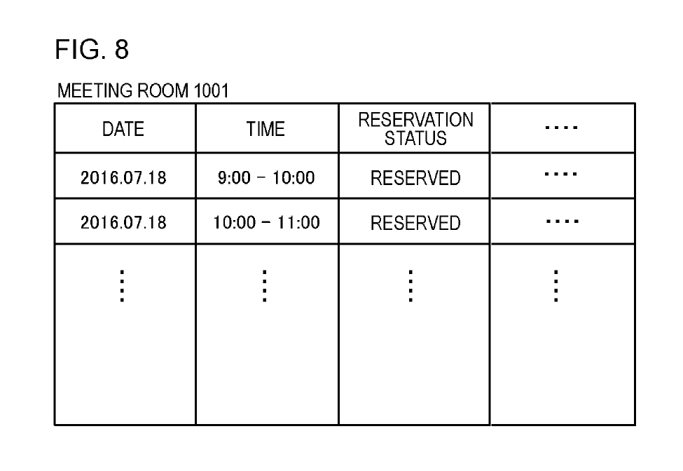

In addition, as described in FIG. 8, the reservation status of each of a plurality of facilities is registered with the reservation server (for example, reservation management server) 20. FIG. 8 describes an example in which a facility is a meeting room. FIG. 8 is information indicating the reservation status of a meeting room 1001, and the date, time and reservation status (the presence or absence of a reservation) are associated with each other. Besides, a user name, contact, and the like may be further associated. Note that, one-hour reservations are made in the example of the drawing, but there is no limitation thereto.

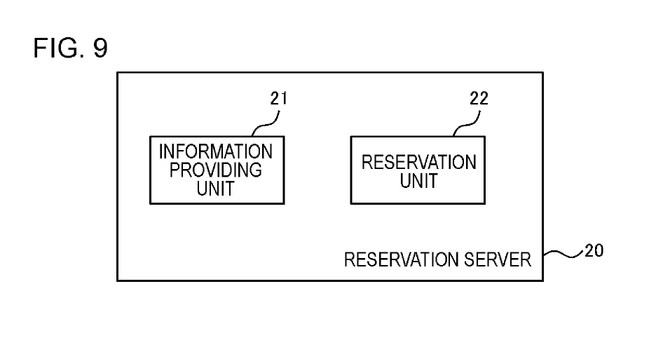

FIG. 9 describes an example of a functional block diagram of the reservation server 20 of the present example embodiment. As described in the drawing, the reservation server 20 includes an information providing unit 21 and a reservation unit 22.

The information providing unit 21 receives terminal information from the terminal apparatus 10, and transmits, to the terminal apparatus 10, facility information indicating a facility and a position thereof, a positional relationship between the facility and the terminal apparatus 10 satisfying a predetermined condition.

As described above, the direction information or the like of the terminal apparatus 10 may be included in the terminal information, in addition to the position information indicating the current position of the terminal apparatus 10. The facility information is information for displaying an air tag. A unit that extracts, on the basis of the terminal information, facility information to be replied to the terminal apparatus 10 from the information providing unit 21 is not particularly limited, but any AR technique may be used. For example, the information providing unit 21 may transmit facility information of a facility located within a predetermined distance from the position of the terminal apparatus 10 to the terminal apparatus 10. In addition, the information providing unit 21 may transmit, to the terminal apparatus 10, facility information of a facility located within a predetermined distance from the position of the terminal apparatus 10 and located in the facing direction of the camera of the terminal apparatus 10. The facing direction of the camera may have a concept of, for example, a range of predetermined angles in vertical and horizontal directions with the optical axis of the camera as the center.

The reservation unit 22 receives reservation information for reserving any of facilities indicated by the facility information from the terminal apparatus 10, and performs reservation processing. The reservation information includes identification information (for example, facility name) of a facility, the date and time (date and time of use), a user's identification information, and the like.

For example, in a case where the facility is available (not reserved) on the date and time indicated by the reservation information, the reservation unit 22 completes the reservation. Specifically, information indicating the reservation status as described in FIG. 8 is updated. That is, the reservation status of the corresponding facility on the corresponding date and time is changed to “reserved”, and the attribute information such as the user name is registered in association therewith. The reservation unit 22 then transmits a notification indicating that the reservation is completed to the terminal apparatus 10.

On the other hand, in a case where the facility is not available (already reserved) on the date and time indicated by the reservation information, the reservation unit 22 transmits a notification indicating that a reservation is not able to be made to the terminal apparatus 10.

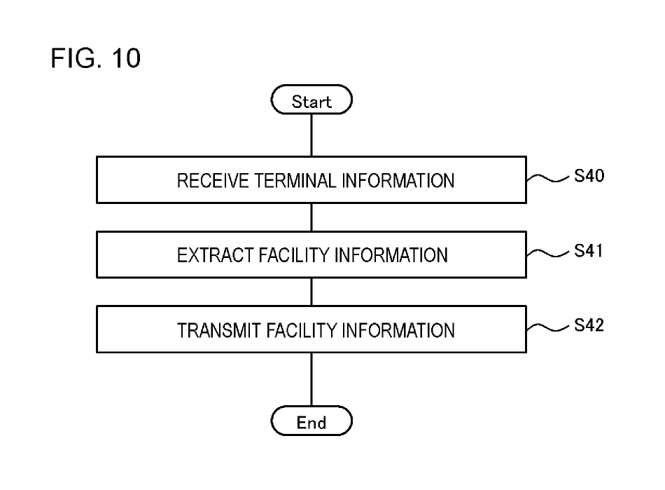

Next, an example of a flow of processes of the reservation server 20 will be described with reference to a flow diagram of FIG. 10.

In a case where the terminal information is received from the terminal apparatus 10 (S40), the information providing unit 21 extracts facility information indicating a facility and a position thereof, a positional relationship between the facility and the terminal apparatus 10 satisfying a predetermined condition (S41), and replies the facility information to the terminal apparatus 10 (S42). Thereafter, in a case where a request for a reservation including reservation information is received from the terminal apparatus 10, the reservation unit 22 performs reservation processing on the basis of the reservation information.

Next, a modification example of the reservation system of the present example embodiment will be described.

For example, the information acquisition unit 11 of the terminal apparatus 10 may further acquire a facility search condition, and transmit the search condition to the reservation server 20. The search condition is inputted by a user. The reservation server 20 extracts facility information of a facility, the facility satisfying the search condition, and a positional relationship between the facility and the terminal apparatus 10 satisfying a predetermined condition, and replies the facility information to the terminal apparatus 10. The information acquisition unit 11 receives, from the reservation server 20, facility information of a facility which satisfies the search condition and whose positional relationship with the own terminal satisfies a predetermined condition. The display control unit 12 causes the display unit to display a screen having a reservation button displayed on a camera-generated image, using the facility information acquired by the information acquisition unit 11. In a case of the modification example, only the reservation button corresponding to the facility satisfying the search condition is superimposedly displayed on the camera-generated image.

For example, the desired date and time of use for the facility may be specified in the search condition. In this case, the information providing unit 21 of the reservation server 20 transmits, to the terminal apparatus 10, facility information of a facility which is available on the desired date and time of use and whose positional relationship with the terminal apparatus 10 satisfies a predetermined condition. The display control unit 12 of the terminal apparatus 10 displays, on the camera-generated image, a reservation button corresponding to the facility which is available on the desired date and time of use and whose positional relationship with the terminal apparatus 10 satisfies a predetermined condition.

As another example, the desired facility room capacity may be specified in the search condition. In this case, the information providing unit 21 of the reservation server 20 transmits, to the terminal apparatus 10, facility information of a facility which meets the desired room capacity (for example, a facility with a room capacity equal to or greater than the desired room capacity) and whose positional relationship with the terminal apparatus 10 satisfies a predetermined condition. The display control unit 12 of the terminal apparatus 10 then displays, on the camera-generated image, a reservation button corresponding to the facility whose positional relationship with the terminal apparatus 10 satisfies a predetermined condition and which meets the desired room capacity.

For example, when a predetermined operation (for example, operation of a search condition setting button which is not shown) is received in a state where the screen as described in FIG. 3 is displayed, the display control unit 12 may cause the display unit to display an input screen for specifying the facility search condition. The information acquisition unit 11 then may acquire the search condition inputted on the input screen.

Another modification example will be described. When an input screen for inputting the details of a reservation as described in FIG. 4 is displayed in response to the operation of a reservation button, the display control unit 12 of the terminal apparatus 10 may display contents different from each other in accordance with a distance between the own terminal and the facility to be reserved.

Specifically, in a case where the distance between the own terminal and the facility to be reserved (facility corresponding to the operated reservation button) is equal to or less than a reference value, on the input screen as described in FIG. 4, the current day may be entered in the date-of-use field (date and time) and a time slot including the current time may be entered in the time-of-use field as default values. In a case where the distance between the own terminal and the facility to be reserved is equal to or less than a reference value, there is a possibility that the user is searching for a facility to be used right away in the vicinity of the facility. When the default values as described above are entered in advance, it is possible to reduce the burden of input work performed by the user. In a case where the distance exceeds a reference value, the entry field in the input screen as described in FIG. 4 may be left blank.

Another modification example will be described. In a case where the number of pieces of facility information acquired by the information acquisition unit 11 exceeds a reference value, the display control unit 12 of the terminal apparatus 10 may display a predetermined number of pieces of the facility information from that closest to the own terminal.

According to the reservation system of the present example embodiment described above, a user can perform reservation processing of a facility from a screen having a reservation button displayed corresponding to each of a plurality of facilities on a camera-generated image displayed in real time. Therefore, a user can intuitively recognize the position and direction of a facility that he is going to reserve. As a result, it is possible to reduce the inconvenience or the like of reserving an unintended facility by mistake.

In addition, according to the reservation system of the present example embodiment, in a case where the search condition is specified, a reservation button can be displayed corresponding to only the facility consistent with the search condition. Since only the necessary information (reservation button of the facility consistent with the search condition) can be displayed without displaying unnecessary information (reservation button of a facility which is not consistent with the search condition), it is possible to efficiently reserve a desired facility.

In addition, according to the reservation system of the present example embodiment, in a case where the distance between the own terminal and a facility to be reserved is equal to or less than a reference value, on the input screen as described in FIG. 4, the current day can be entered in the field of the date (date and time) of use and a time slot including the current time can be entered in the field of the time of use, as default values. In a case where the distance between the own terminal and a facility to be reserved is equal to or less than a reference value, there is a possibility that the user is searching for a facility to be used right away in the vicinity of the facility. In a case where the default values as described above are entered in advance, it is possible to reduce a burden of input work performed by the user.

In addition, according to the reservation system of the present example embodiment, in a case where the number of reservation buttons to be displayed on a screen exceeds a reference value (in a case where the number of pieces of facility information acquired by the information acquisition unit 11 exceeds a reference value), it is possible to display a predetermined number of pieces of facility information from that closest to the own terminal. The efficiency of facility selection work or the like performed by a user is improved by suppressing the amount of information to be displayed.

### Second Example Embodiment

First, the outline of the present example embodiment will be described. A reservation system of the present example embodiment includes a reservation mode using the air tag described in the first example embodiment (hereinafter, referred to as an “air tag reservation mode”) and a reservation mode without using the air tag (hereinafter, referred to as a “normal reservation mode”). These reservation modes are automatically switched in accordance with the state of the terminal apparatus 10. Hereinafter, the detailed description thereof will be given.

An example of the hardware configuration of a terminal apparatus 10 and a reservation server 20 of the present example embodiment is the same as that in the first example embodiment.

Next, the function of a reservation system of the present example embodiment will be described. The reservation system includes the terminal apparatus 10 and the reservation server 20. The terminal apparatus 10 and the reservation server 20 are connected to a network such as the Internet, and are configured to be capable of communicating with each other.

First, the function of the terminal apparatus 10 will be described. The terminal apparatus 10 is a portable terminal which is carried by a user, and has a camera function, a communication function, and the like. Examples of the terminal apparatus 10 to be exemplified include a smartphone, a cellular phone, a tablet, a notebook personal computer, and the like, but there is no limitation thereto.

FIG. 2 describes an example of a functional block diagram of the terminal apparatus 10 of the present example embodiment. As described in the drawing, the terminal apparatus 10 includes an information acquisition unit 11, a display control unit 12, and a reservation processing unit 13. For example, the functions of these units are implemented by installing predetermined reservation software on the terminal apparatus 10.

In a case where the state of the own terminal satisfies a first condition, the information acquisition unit 11 transmits terminal information to the reservation server 20 to request for facility information, and thus can receive the facility information from the reservation server 20.

On the other hand, in a case where the state of the own terminal does not satisfy the first condition, the information acquisition unit 11 requests a reservation screen of a normal reservation mode (second reservation screen) from the reservation server 20, and thus can receive the input screen from the reservation server 20.

The first condition may establish that, for example, the own terminal is located or is not located within a predetermined space which is set in advance. For example, the first condition may be that “the own terminal is present within an area in which the user's company exists”, “the own terminal is present within an area in which the user's department exists”, or the like. It should be noted that the descriptions herein are merely examples, and there are no limitations thereto.

Alternatively, the first condition may establish that, for example, a positional relationship between the own terminal and a facility satisfies or does not satisfy a predetermined condition. For example, the first condition may be that “a distance between the own terminal and a facility is equal to or less than a reference value” or the like.

In addition, the first condition may establish that, for example, the inclination angle of the own terminal satisfies or does not satisfy a predetermined condition. For example, the first condition may be that “the own terminal is not in a laid state”, “the own terminal is in a standing state”, or the like. The laid state or the standing state can be defined using, for example, the inclination angle or the like of the own terminal from a reference state (for example, state horizontal to the ground).

In a case where the state of the own terminal satisfies the first condition, the display control unit 12 causes the display unit to display a reservation screen (first reservation screen) having a reservation button displayed on a camera-generated image, for example, as described in FIG. 3.

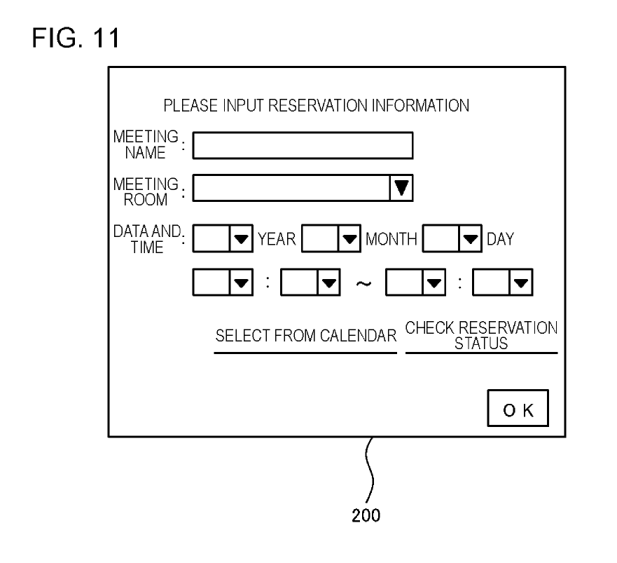

On the other hand, in a case where the state of the own terminal does not satisfy the first condition, the display control unit 12 causes the display unit to display a second reservation screen (reservation screen of a normal reservation mode) different from the first reservation screen, for example, as described in FIG. 11. The second reservation screen (screen 200) includes a plurality of entry fields for specifying the details of a reservation.

In a case where the state of the own terminal satisfies the first condition, the reservation processing unit 13 receives reservation processing from the reservation screen (first reservation screen) having a reservation button displayed on the camera-generated image, for example, as described in FIG. 3. The reservation processing is as described in the first example embodiment.

On the other hand, in a case where the state of the own terminal does not satisfy the first condition, the reservation processing unit 13 receives reservation processing from the second reservation screen (reservation screen of a normal reservation mode) different from the first reservation screen, for example, as described in FIG. 11. For example, the reservation processing unit 13 receives an input of detailed information of a reservation from the second reservation screen. The reservation processing unit 13 transmits reservation information including the received detailed information to the reservation server 20, and requests the reservation to be processed.

Other configurations of the information acquisition unit 11, the display control unit 12 and the reservation processing unit 13 are the same as those in the first example embodiment.

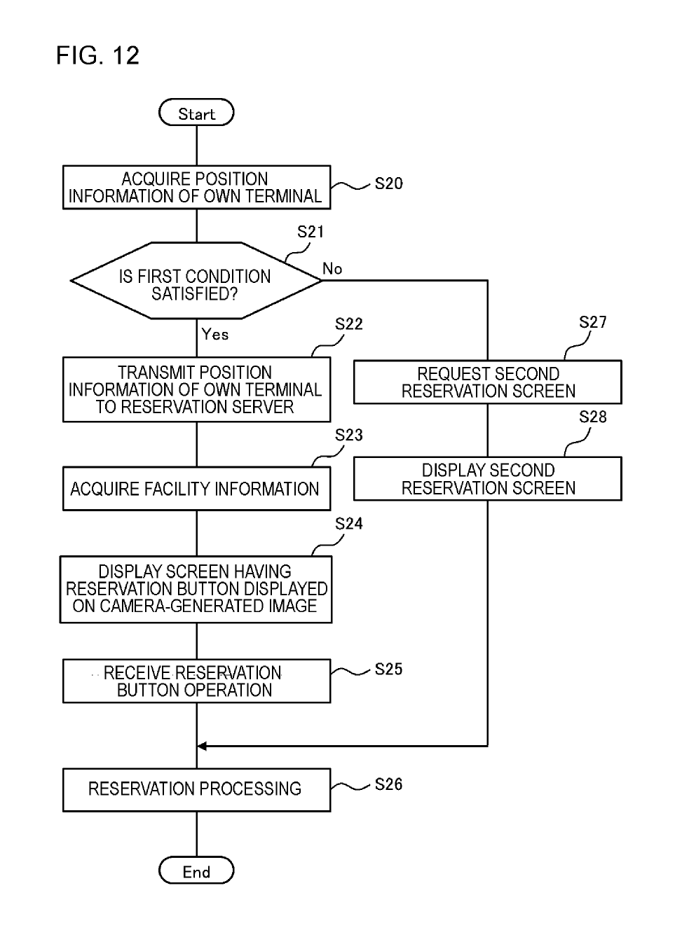

Here, an example of a flow of processes of the terminal apparatus 10 will be described with reference to a flow diagram of FIG. 12.

When the reservation software is started up by operating the terminal apparatus 10 (or when an input is made to start the reservation processing after startup of the reservation software), the information acquisition unit 11 acquires state information such as position information indicating the current position of the own terminal or direction information indicating the direction of the own terminal in response thereto (S20). The information acquisition unit 11 then determines whether the state of the own terminal satisfies the first condition, on the basis of the state information.

In a case where the first condition is satisfied (Yes in S21), the information acquisition unit 11 transmits the position information of the own terminal to the reservation server (S22). The direction information of the own terminal may be further transmitted to the reservation server in S22. Thereafter, the information acquisition unit 11 receives facility information replied from the reservation server (S23).

Next, the display control unit 12 causes the display unit to display a screen having a reservation button corresponding to a facility superimposedly displayed on a camera-generated image, using the facility information received in S23 (S24). When an operation of the reservation button on the screen is received (S25), the reservation processing unit 13 executes reservation processing for reserving a facility corresponding to the reservation button (S26).

On the other hand, in a case where the first condition is not satisfied (No in S21), the information acquisition unit 11 requests the second reservation screen (reservation screen of a normal reservation mode) from the reservation server (S27). Next, the display control unit 12 causes the display unit to display the second reservation screen received in S27 (S28). The reservation processing unit 13 receives an operation on the second reservation screen, and executes reservation processing (S26).

In a case where terminal information is received from the terminal apparatus 10, the information providing unit 21 of the reservation server 20 replies facility information to the terminal apparatus 10. On the other hand, in a case where a request for the reservation screen of a normal reservation mode (second reservation screen) is received from the terminal apparatus 10, the information providing unit 21 replies the second reservation screen to the terminal apparatus 10. Other configurations of the information providing unit 21 are the same as those in the first example embodiment. In addition, the configuration of the reservation unit 22 is the same as that in the first example embodiment.

Next, a modification example of the reservation system of the present example embodiment will be described. In the above example, the terminal apparatus 10 determines whether the first condition is satisfied. In the modification example, the reservation server 20 may perform the determination.

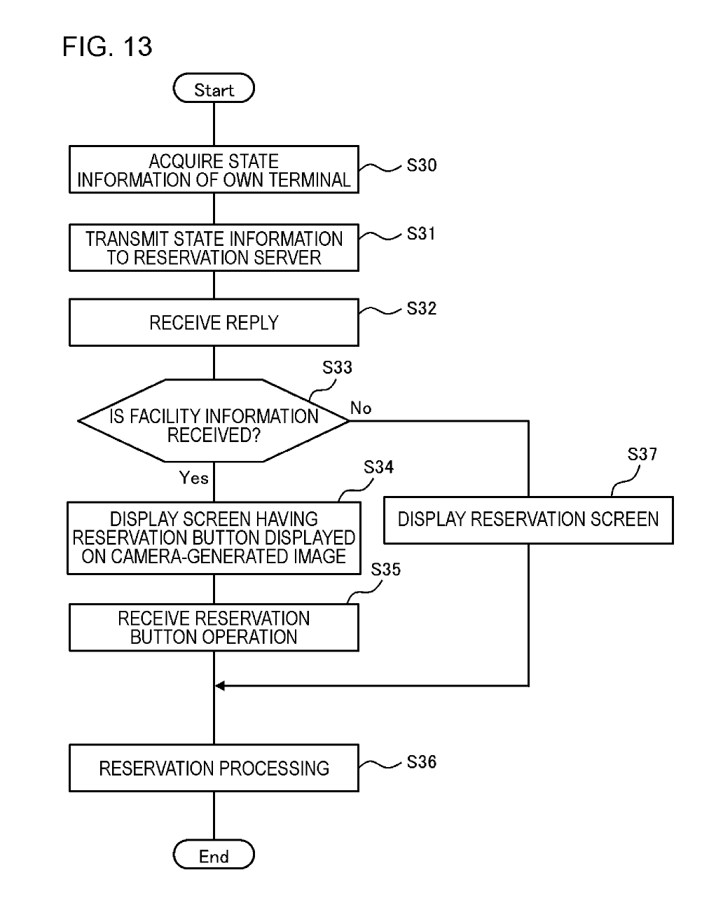

Here, an example of a flow of processes of the terminal apparatus 10 in the modification example will be described with reference to a flow diagram of FIG. 13.

When the reservation software is started up by operating the terminal apparatus 10 (or, when an input is made to start the reservation processing after startup of the reservation software), in response thereto, the information acquisition unit 11 acquires state information such as position information indicating the current position of the own terminal or direction information indicating the direction of the own terminal (S30). The information acquisition unit 11 then transmits the state information to the reservation server 20 (S31), and receives a reply from the reservation server 20 (S32).

In a case where the facility information is received as a reply (Yes in S33), the display control unit 12 causes the display unit to display a screen having a reservation button, which corresponds to a facility, superimposedly displayed on a camera-generated image, using the facility information received in S32 (S34). In a case where an operation of the reservation button is received on the screen (S35), the reservation processing unit 13 executes reservation processing for reserving a facility corresponding to the reservation button (S36).

On the other hand, in a case where the second reservation screen (reservation screen of a normal reservation mode) is received as a reply (No in S33), the display control unit 12 causes the display unit to display the second reservation screen received in S32 (S37). The reservation processing unit 13 receives an operation on the second reservation screen, and executes reservation processing (S36).

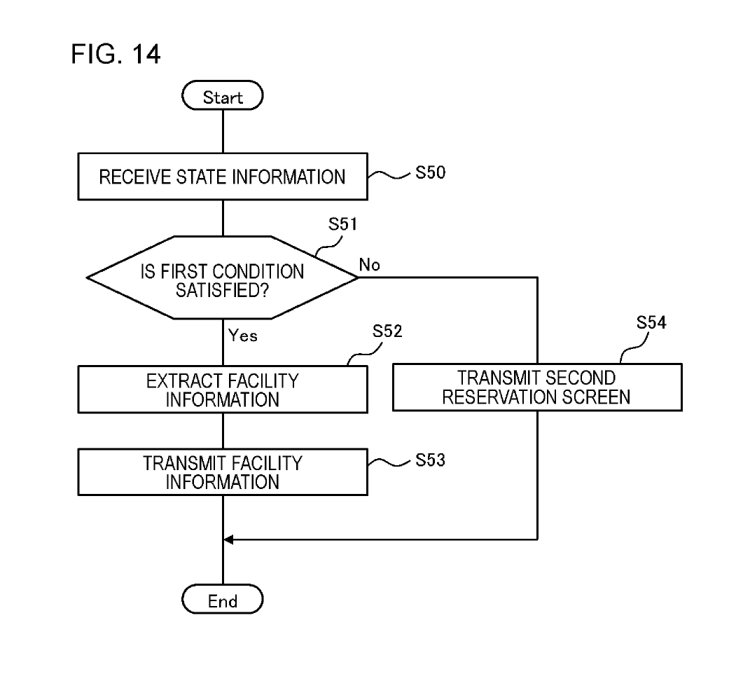

Next, an example of a flow of processes of the reservation server 20 in the modification example will be described with reference to a flow diagram of FIG. 14.

When the state information is received from the terminal apparatus 10 (S50), the information providing unit 21 determines whether the state of the terminal apparatus 10 satisfies the first condition, on the basis of the state information.

In a case where the first condition is satisfied (Yes in S51), facility information indicating a facility and a position thereof, a positional relationship between the facility and the terminal apparatus 10 satisfying a predetermined condition, is extracted (S52), and is replied to the terminal apparatus 10 (S53). On the other hand, in a case where the first condition is not satisfied (No in S51), the second reservation screen is replied to the terminal apparatus 10 (S54). Thereafter, in a case where a request for a reservation including reservation information is received from the terminal apparatus 10, the reservation unit 22 performs reservation processing on the basis of the reservation information.

According to the reservation system of the present example embodiment described above, it is possible to implement the same advantageous effect as that in the first example embodiment.

In addition, according to the reservation system of the present example embodiment, the reservation system includes a reservation mode (air tag reservation mode) using an air tag and a reservation mode (normal reservation mode) without using an air tag, and thus it is possible to automatically switch these reservation modes in accordance with the state of the terminal apparatus 10.

For example, in a case where the terminal apparatus 10 is located far away from any facility, no reservation button is displayed on the camera-generated image even when the air tag reservation mode is started up. In such a case, the user is not able to proceed to reservation processing of a facility. Consequently, the reservation modes can be switched in accordance with the distance between the terminal apparatus 10 and a facility. Specifically, in a case where the distance between the terminal apparatus 10 and a facility is equal to or less than a reference value, and a reservation button is displayed on the camera-generated image, the air tag reservation mode is selected. On the other hand, in a case where the distance between the terminal apparatus 10 and a facility is equal to or greater than a reference value, and no reservation button is displayed on the camera-generated image, the normal reservation mode is selected.

According to such a reservation system of the present example embodiment, a user-friendly system capable of efficiently performing reservation processing of a facility is implemented.

Moreover, in a case where the terminal apparatus 10 is in a laid state, the camera is directed to the ceiling or the floor and an image of a facility is not captured even when the air tag reservation mode is started up. In such a case, the user is not able to proceed to the reservation processing of a facility. Accordingly, the reservation modes can be switched in accordance with the laid state or the standing state of the terminal apparatus 10. Specifically, in a case where the terminal apparatus 10 is in a standing state, the air tag reservation mode is selected. On the other hand, in a case where the terminal apparatus 10 is in the laid state, the normal reservation mode is selected.

According to such a reservation system of the present example embodiment, a user-friendly system capable of efficiently performing reservation processing of a facility is implemented.

Hereinafter, examples of reference forms are appended.

1. A terminal apparatus including:

an information acquisition unit that transmits, to a reservation server, terminal information indicating a position of an own terminal, and receives, from the reservation server, facility information indicating a facility and a position thereof, a positional relationship between the facility and the own terminal satisfying a predetermined condition;

a display control unit that causes a display unit to display a camera-generated image and to display a reservation button on the camera-generated image at a position corresponding to the position of the facility indicated by the facility information; and

a reservation processing unit that executes, when the reservation button is operated, reservation processing for reserving the facility corresponding to the reservation button.

2. The terminal apparatus according to 1,

wherein the display control unit causes the display unit to

display a first reservation screen displaying the camera-generated image and the reservation button on the camera-generated image when the state of the own terminal satisfies a first condition, and

display a second reservation screen different from the first reservation screen when the state of the own terminal does not satisfy the first condition.

3. The terminal apparatus according to 2,

wherein the information acquisition unit

receives the facility information from the reservation server when the state of the own terminal satisfies the first condition, and

receives the second reservation screen from the reservation server when the state of the own terminal does not satisfy the first condition.

4. The terminal apparatus according to 3,

wherein the information acquisition unit

transmits the terminal information to the reservation server to request for the facility information when the state of the own terminal satisfies the first condition, and

requests the second reservation screen from the reservation server when the state of the own terminal does not satisfy the first condition.

5. The terminal apparatus according to any one of 2 to 4, wherein the first condition establishes that the own terminal is located or is not located within a predetermined space which is set in advance.

6. The terminal apparatus according to any one of 2 to 4, wherein the first condition establishes that a positional relationship between the own terminal and a facility satisfies or does not satisfy a predetermined condition.

7. The terminal apparatus according to 6, wherein the first condition requires that a distance between the own terminal and a facility is equal to or less than a reference value.

8. The terminal apparatus according to any one of 1 to 7,

wherein the information acquisition unit acquires a search condition for a facility, and

the display control unit displays a reservation button on the camera-generated image at a position corresponding to a position of a facility, the facility satisfying the search condition, and a positional relationship between the facility and the own terminal satisfying a predetermined condition.

9. The terminal apparatus according to 8,

wherein the search condition specifies a desired date and time of use for a facility, and

the display control unit causes the display unit to display a reservation button on the camera-generated image at a position corresponding to a position of a facility, the facility satisfying the search condition, and a positional relationship between the facility and the own terminal satisfying a predetermined condition.

10. The terminal apparatus according to 8,

wherein the search condition specifies a desired facility room capacity, and

the display control unit causes the display unit to display a reservation button on the camera-generated image at a position corresponding to a position of a facility, the facility satisfying the search condition, and a positional relationship between the facility and the own terminal satisfying a predetermined condition.

11. The terminal apparatus according to any one of 1 to 10,

wherein the display control unit causes the display unit to

display, when the reservation button is operated, an input screen including an entry field for inputting detail of a reservation including date and time, and

display, when a distance between the own terminal and a facility is equal to or less than a reference value, the input screen including a date-of-use field inputted with the current date and a time-of-use field inputted with a time slot including the current time as default values.

12. A reservation server including:

an information providing unit that receives, from a terminal apparatus, terminal information indicating a position of the terminal apparatus, and transmits, to the terminal apparatus, facility information indicating a facility and a position thereof, a positional relationship between the facility and the terminal apparatus satisfying a predetermined condition; and

a reservation unit that receives, from the terminal apparatus, reservation information for reserving any one facility indicated by the facility information, and performs reservation processing.

13. The reservation server according to 12,

wherein the information providing unit receives, from the terminal apparatus, a search condition of a facility, and transmits, to the terminal apparatus, the facility information indicating a facility and a position thereof, a positional relationship between the own terminal and the facility satisfying a predetermined condition, and the facility and the position thereof satisfying the search condition.

14. The reservation server according to 13,

wherein the search condition specifies a desired date and time of use for a facility, and

the information providing unit transmits, to the terminal apparatus, the facility information indicating a facility and a position thereof, a positional relationship between the own terminal and the facility satisfying a predetermined condition, and the facility being available on the desired date and time of use.

15. The reservation server according to 13,

wherein the search condition specifies a desired facility room capacity, and

the information providing unit transmits, to the terminal apparatus, the facility information indicating a facility and a position thereof, a positional relationship between the own terminal and the facility satisfying a predetermined condition, and the facility being capable of accommodating the desired room capacity.

16. The reservation server according to any one of 12 to 15,

wherein the information providing unit

transmits, when a state of the terminal apparatus satisfies a first condition, the facility information to the terminal apparatus, and transmits, when the state of the terminal apparatus does not satisfy the first condition, a reservation screen different from a screen having a reservation button displayed on a camera-generated image to the terminal apparatus.

17. A reservation system including:

the terminal apparatus according to any one of 1 to 11; and

the reservation server according to any one of 12 to 16.

18. A processing method of a terminal apparatus, the method including the steps, executed by a computer, of:

an information acquisition step of transmitting, to a reservation server, terminal information indicating a position of an own terminal, and receiving, from the reservation server, facility information indicating a facility and a position thereof, a positional relationship between the facility and the own terminal satisfying a predetermined condition;

a display control step of causing a display unit to display a camera-generated image and to display a reservation button on the camera-generated image at a position corresponding to the position of the facility indicated by the facility information; and

a reservation processing step of executing, when the reservation button is operated, reservation processing for reserving the facility corresponding to the reservation button.

19. A program causing a computer to function as:

an information acquisition unit that transmits, to a reservation server, terminal information indicating a position of an own terminal, and receives, from the reservation server, facility information indicating a facility and a position thereof, a positional relationship between the facility and the own terminal satisfying a predetermined condition;

a display control unit that causes a display unit to display a camera-generated image and to display a reservation button on the camera-generated image at a position corresponding to the position of the facility indicated by the facility information; and

a reservation processing unit that executes, when the reservation button is operated, reservation processing for reserving the facility corresponding to the reservation button.

20. A processing method of a reservation server, the method including the steps, executed by a computer, of:

an information providing step of receiving, from a terminal apparatus, terminal information indicating a position of the terminal apparatus, and transmitting, to the terminal apparatus, facility information indicating a facility and a position thereof, a positional relationship between the facility and the terminal apparatus satisfying a predetermined condition; and

a reservation step of receiving, from the terminal apparatus, reservation information for reserving any one facility indicated by the facility information, and performing reservation processing.

21. A program causing a computer to function as:

an information providing unit that receives, from a terminal apparatus, terminal information indicating a position of the terminal apparatus, and transmits, to the terminal apparatus, facility information indicating a facility and a position thereof, a positional relationship between the facility and the terminal apparatus satisfying a predetermined condition; and

a reservation unit that receives, from the terminal apparatus, reservation information for reserving any one facility indicated by the facility information, and performs reservation processing.

This application is based on Japanese Patent Application No. 2017-000379 filed on Jan. 5, 2017, the content of which is incorporated hereinto by reference.

It is apparent that the present invention is not limited to the above embodiment, and may be modified and changed without departing from the scope and spirit of the invention.

What is claimed is:

1. A terminal apparatus comprising:
an information acquisition unit that transmits, to a reservation server, terminal information indicating a position of an own terminal, and receives, from the reservation server, facility information indicating a facility and a position thereof, a positional relationship between the facility and the own terminal satisfying a predetermined condition;
a display control unit that causes a display unit to display a camera-generated image and to display a reservation button on the camera-generated image at a position corresponding to the position of the facility indicated by the facility information; and
a reservation processing unit that executes, when the reservation button is operated, reservation processing for reserving the facility corresponding to the reservation button.

2. The terminal apparatus according to claim 1,
wherein the display control unit causes the display unit to
display a first reservation screen displaying the camera-generated image and the reservation button on the camera-generated image when the state of the own terminal satisfies a first condition, and
display a second reservation screen different from the first reservation screen when the state of the own terminal does not satisfy the first condition.

3. The terminal apparatus according to claim 2,
wherein the information acquisition unit
receives the facility information from the reservation server when the state of the own terminal satisfies the first condition, and
receives the second reservation screen from the reservation server when the state of the own terminal does not satisfy the first condition.

4. The terminal apparatus according to claim 3,
wherein the information acquisition unit
transmits the terminal information to the reservation server to request for the facility information when the state of the own terminal satisfies the first condition, and
requests the second reservation screen from the reservation server when the state of the own terminal does not satisfy the first condition.

5. The terminal apparatus according to claim 2, wherein the first condition establishes that the own terminal is located or is not located within a predetermined space which is set in advance.

6. The terminal apparatus according to claim 2, wherein the first condition establishes that a positional relationship between the own terminal and a facility satisfies or does not satisfy a predetermined condition.

7. The terminal apparatus according to claim 6, wherein the first condition requires that a distance between the own terminal and a facility is equal to or less than a reference value.

8. The terminal apparatus according to claim 1,
wherein the information acquisition unit acquires a search condition for a facility, and
the display control unit displays a reservation button on the camera-generated image at a position corresponding to a position of a facility, the facility satisfying the search condition, and a positional relationship between the facility and the own terminal satisfying a predetermined condition.

9. The terminal apparatus according to claim 8,
wherein the search condition specifies a desired date and time of use for a facility, and the display control unit causes the display unit to display a reservation button on the camera-generated image at a position corresponding to a position of a facility, the facility satisfying the search condition, and a positional relationship between the facility and the own terminal satisfying a predetermined condition.

10. The terminal apparatus according to claim 8,
wherein the search condition specifies a desired facility room capacity, and
the display control unit causes the display unit to display a reservation button on the camera-generated image at a position corresponding to a position of a facility, the facility satisfying the search condition, and a positional relationship between the facility and the own terminal satisfying a predetermined condition.

11. The terminal apparatus according to claim 1,
wherein the display control unit causes the display unit to
display, when the reservation button is operated, an input screen including an entry field for inputting detail of a reservation including date and time, and
display, when a distance between the own terminal and a facility is equal to or less than a reference value, the input screen including a date-of-use field inputted with the current date and a time-of-use field inputted with a time slot including the current time as default values.

12. A reservation server comprising:
an information providing unit that receives, from a terminal apparatus, terminal information indicating a position of the terminal apparatus, and transmits, to the terminal apparatus, facility information indicating a facility and a position thereof, a positional relationship between the facility and the terminal apparatus satisfying a predetermined condition; and
a reservation unit that receives, from the terminal apparatus, reservation information for reserving any one facility indicated by the facility information, and performs reservation processing.

13. The reservation server according to claim 12,
wherein the information providing unit receives, from the terminal apparatus, a search condition of a facility, and transmits, to the terminal apparatus, the facility information indicating a facility and a position thereof, a positional relationship between the own terminal and the facility satisfying a predetermined condition, and the facility and the position thereof satisfying the search condition.

14. The reservation server according to claim 13,
wherein the search condition specifies a desired date and time of use for a facility, and
the information providing unit transmits, to the terminal apparatus, the facility information indicating a facility and a position thereof, a positional relationship between the own terminal and the facility satisfying a predetermined condition, and the facility being available on the desired date and time of use.

15. The reservation server according to claim 13,
wherein the search condition specifies a desired facility room capacity, and
the information providing unit transmits, to the terminal apparatus, the facility information indicating a facility and a position thereof, a positional relationship between the own terminal and the facility satisfying a predetermined condition, and the facility being capable of accommodating the desired room capacity.

16. The reservation server according to claim 12,
wherein the information providing unit
transmits, when a state of the terminal apparatus satisfies a first condition, the facility information to the terminal apparatus, and
transmits, when the state of the terminal apparatus does not satisfy the first condition, a reservation screen different from a screen having a reservation button displayed on a camera-generated image to the terminal apparatus.

17. A processing method of a terminal apparatus, the method comprising the steps, executed by a computer, of:
an information acquisition step of transmitting, to a reservation server, terminal information indicating a position of an own terminal, and receiving, from the reservation server, facility information indicating a facility and a position thereof, a positional relationship between the facility and the own terminal satisfying a predetermined condition;
a display control step of causing a display unit to display a camera-generated image and to display a reservation button on the camera-generated image at a position corresponding to the position of the facility indicated by the facility information; and
a reservation processing step of executing, when the reservation button is operated, reservation processing for reserving the facility corresponding to the reservation button.
